(19) United States
(12) Patent Application Publication
(10) Pub. No.: US 2026/0238706 A1
(43) Pub. Date: Aug. 13, 2026

(54) Handling of Network Basic Input/Output System (Netbios) Over Transmission Control Protocol / Internet Protocol (TCP/IP) (NBT) Protocol Frames for Reduced Power Consumption

(71) Applicant: QUALCOMM Incorporated, San Diego, CA (US)

(72) Inventors: Liwei Zhang, Beijing (CN); Zhaoming Shu, Nanjing (CN)

(21) Appl. No.: 19/160,451

(22) PCT Filed: Feb. 27, 2023
(86) PCT No.: PCT/CN2023/078363

§ 371 Date: Aug. 27, 2025

(51) Int. Cl. H04L 69/163; H04L 61/30; H04W 52/02

(52) U.S. Cl. CPC H04L 69/163; H04L 61/30; H04W 52/0212

(57) ABSTRACT

This disclosure provides methods, components, devices, and systems for handling packets that include Network Basic Input/Output System (NetBIOS) over Transmission Control Protocol/Internet Protocol (TCP/IP) (NBT) protocol frames. Some aspects specifically relate to handling a Net-BIOS Name Service (NBNS) frame received by a wireless connectivity processor (such as a Wi-Fi processor) of a wireless communication device while the Wi-Fi processor is operating in a standby (for example, a wake-on-wireless (WOW)) mode and an application processor of the wireless communication device is operating in a standby mode. In some examples, in response to receiving an NBNS unicast packet while the Wi-Fi processor is operating in the WOW mode and the application processor is operating in the standby mode, the Wi-Fi processor processes the received NBNS unicast packet in firmware and caches the processing results, but does not send a wake-up message to the application processor to wake it up from standby mode.

### TECHNICAL FIELD

This disclosure relates generally to wireless communication, and more specifically, to techniques for handling Network Basic Input/Output System (NetBIOS) over Transmission Control Protocol/Internet Protocol (TCP/IP) (NBT) protocol frames for reduced power consumption.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

A wireless communication device, such as an AP or a STA, may generally include both an application processor and a Wi-Fi processor. During regular operations, an AP and a STA may exchange multiple packets, which may be broadcast, multicast, or unicast packets. As packets are received by the respective wireless communication device, they are first received and processed by the Wi-Fi processor and then further processed by the application processor. In some instances, the application processor may periodically enter into a sleep or standby mode to conserve power. In some instances, the Wi-Fi processor may also enter into a standby mode, also referred to as wake on wireless (WOW) mode, to listen for packets. Typically, each time a packet is received by the Wi-Fi processor, the Wi-Fi processor sends a wake-up message to the application processor. Responsive to receiving the wake-up message, the application processor wakes-up (for example, enters an active mode) and processes the packet, which may be handed to the application processor by the Wi-Fi processor through a Dial-on-demand routing (DDR) scheme.

The application processor may then remain in the active mode, such as if a display screen of the wireless communication device is on, or may return to the sleep or standby mode otherwise. The application processor consumes power as it processes packets. The application processor executes other software applications running at the same time on the device, and the device may exploit this wakeup opportunity to send packets for a keepalive (KA) usage or other usage. A KA is a message sent by one device to another device to check that the link between the two devices is active and operating, or to prevent the link between the two devices from being broken. These other actions consume additional power by the wireless communication device.

### SUMMARY

The systems, methods and devices of this disclosure each have several innovative aspects, no single one of which is solely responsible for the desirable attributes disclosed herein.

One innovative aspect of the subject matter described in this disclosure can be implemented in a wireless communication device. The wireless communication device includes a first processor and a first memory coupled to the first processor. A second processor with a second memory coupled to the second processor. In response to receiving a NBNS unicast packet, the first processor processes the packet, and caching the updated processing results, and not waking the second processor from standby mode. When the first processor receives a non-NBNS unicast packet, the first processor wakes the second processor from standby mode, which then handles the cached NBNS processing results for synchronization, along with the other unicast packet. In this manner, power consumption of the wireless communication device is reduced.

Another innovative aspect of the subject matter described in this disclosure can be implemented in a method for wireless communication. The method includes establishing a communication between an access point and device receiving a NBNS unicast packet, and upon determining that the device is in WOW mode, not waking the device in response to receiving the NBNS packet, and processing the packet, caching the processing results. Upon receiving a non-NBNS packet, the non-NBNS packet and the cached NBNS packet processing results are processed.

Another innovative aspect of the subject matter described in this disclosure can be implemented in a method for wireless communication. The method includes reducing power consumption of the wireless communication device by not waking the device in response to receiving the NBNS packet, and processing the packet, caching the processing results. Upon receiving a non-NBNS packet, the non-NBNS packet and the cached NBNS packet processing results are processed.

In some examples, the methods and wireless communication devices may include establishing a 2.4 GHz, 5 GHz or 6 GHz band communication from an access point in the form of a NBNS unicast packet, and upon determining that the device is in WOW mode, processing the packet, and caching the processing results. Upon receiving another non-NBNS packet, waking the device to process the cached NBNS packet processing results and the non-NBNS packet.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows a diagram of an example wireless communication device operable to handle packets in a wireless communication network.

FIG. 3 shows a flowchart illustrating an example process for handling packets received by a wireless communication device.

FIG. 4 shows a diagram of an example wireless communication device that supports handling Network Basic Input/Output System (NetBIOS) over Transmission Control Protocol/Internet Protocol (TCP/IP) (NBT) protocol frames for reduced power consumption.

FIG. 5 shows a flowchart illustrating an example process that supports handling NBT protocol frames for reduced power consumption.

FIG. 6 shows a flowchart illustrating an example process that supports handling NBT protocol frames for reduced power consumption.

FIG. 7 shows a flowchart illustrating an example process that supports handling NBT protocol frames for reduced power consumption.

FIG. 8 shows a block diagram of an example wireless communication device that supports handling NBT protocol frames for reduced power consumption.

FIG. 9 shows a block diagram of an example wireless communication device that supports handling NBT protocol frames for reduced power consumption.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3^{rd} Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO. The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IOT) network.

Various aspects relate generally to handling packets that include Network Basic Input/Output System (NetBIOS) over Transmission Control Protocol/Internet Protocol (TCP/IP) (NBT) protocol frames, and more specifically to the handling of a NetBIOS Name Service (NBNS) frame received by a wireless connectivity processor (for example, a Wi-Fi processor) of a wireless communication device while the Wi-Fi processor is operating in a standby mode (also referred to as a wake-on-wireless (WOW) mode) and an application processor of the wireless communication device is operating in a standby or sleep mode (hereinafter used interchangeably). In some aspects, in response to receiving a unicast packet that includes an NBNS frame (also referred to herein as an NBNS unicast packet) while the Wi-Fi processor is operating in the WOW mode and the application processor is operating in the standby mode, the Wi-Fi processor performs an initial processing on the received NBNS unicast packet in firmware and caches the processing results, but does not send a wake-up message to the application processor to wake it from the standby mode. In contrast, in some examples, when the Wi-Fi processor subsequently receives a non-NBNS unicast packet, the Wi-Fi processor then sends a wake-up message to wake the application processor from the standby mode. In such examples, the application processor then performs further processing on the cached NBNS packet processing results along with the other non-NBNS unicast packet.

Particular aspects of the subject matter described in this disclosure can be implemented to realize one or more of the following potential advantages. In some examples, because the Wi-Fi processor refrains from triggering a wake-up operation associated with the application processor upon receiving an NBNS frame, one or more aspects of the present disclosure enable a reduction in power consumption by the wireless communication device. The wireless communication device may therefore be able to handle additional tasks on a battery's charge and/or battery life may be extended.

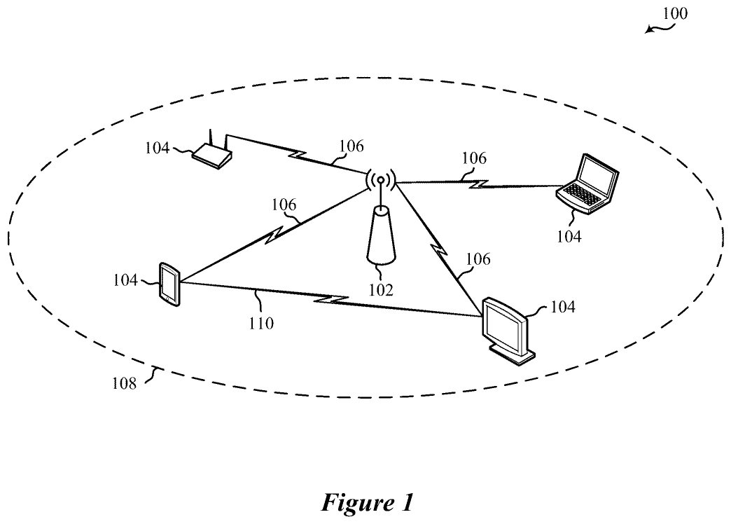

FIG. 1 shows a pictorial diagram of an example wireless communication network 100. According to some aspects, the wireless communication network 100 can be an example of a wireless local area network (WLAN) such as a Wi-Fi network (and will hereinafter be referred to as WLAN 100). For example, the WLAN 100 can be a network implementing at least one of the IEEE 802.11 family of wireless communication protocol standards (such as that defined by the IEEE 802.11-2020 specification or amendments thereof including, but not limited to, 802.11ay, 802.11ax, 802.11az, 802.11ba, 802.11bd, 802.11be, 802.11bf, and the 802.11 amendment associated with Wi-Fi 8). The WLAN 100 may include numerous wireless communication devices such as a wireless AP 102 and multiple wireless STAs 104. While only one AP 102 is shown in FIG. 1, the WLAN network 100 also can include multiple APs 102. AP 102 shown in FIG. 1 can represent various different types of APs including but not limited to enterprise-level APs, single-frequency APs, dual-band APs, standalone APs, software-enabled APs (soft APs), and multi-link APs. The coverage area and capacity of a cellular network (such as LTE, 5G NR, etc.) can be further improved by a small cell which is supported by an AP serving as a miniature base station. Furthermore, private cellular networks also can be set up through a wireless area network using small cells.

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, personal digital assistant (PDAs), other handheld devices, netbooks, notebook computers, tablet computers, laptops, chromebooks, extended reality (XR) headsets, wearable devices, display devices (for example, TVs (including smart TVs), computer monitors, navigation systems, among others), music or other audio or stereo devices, remote control devices (“remotes”), printers, kitchen appliances (including smart refrigerators) or other household appliances, key fobs (for example, for passive keyless entry and start (PKES) systems), Internet of Things (IoT) devices, and vehicles, among other examples. The various STAs 104 in the network are able to communicate with one another via the AP 102.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the WLAN 100. The BSS may be identified or indicated to users by a service set identifier (SSID), as well as to other devices by a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function for establishing or maintaining timing synchronization with the AP 102. The AP 102 may provide access to external networks to various STAs 104 in the WLAN via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz or 60 GHz bands). To perform passive scanning, a STA 104 listens for beacons, which are transmitted by respective APs 102 at a periodic time interval referred to as the target beacon transmission time (TBTT) (measured in time units (TUs) where one TU may be equal to 1024 microseconds (μs)). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA or to select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger wireless network such as the WLAN 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

The APs 102 and STAs 104 may function and communicate (via the respective communication links 106) according to one or more of the IEEE 802.11 family of wireless communication protocol standards. These standards define the WLAN radio and baseband protocols for the PHY and MAC layers. The APs 102 and STAs 104 transmit and receive wireless communications (hereinafter also referred to as “Wi-Fi communications” or “wireless packets”) to and from one another in the form of PHY protocol data units (PPDUs). The APs 102 and STAs 104 in the WLAN 100 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some examples of the APs 102 and STAs 104 described herein also may communicate in other frequency bands, such as the 5.9 GHz and the 6 GHz bands, which may support both licensed and unlicensed communications. The APs 102 and STAs 104 also can communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac, 802.11ax and 802.11be standard amendments may be transmitted over the 2.4, 5 GHz or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 or 320 MHz by bonding together multiple 20 MHz channels.

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 protocol to be used to transmit the payload.

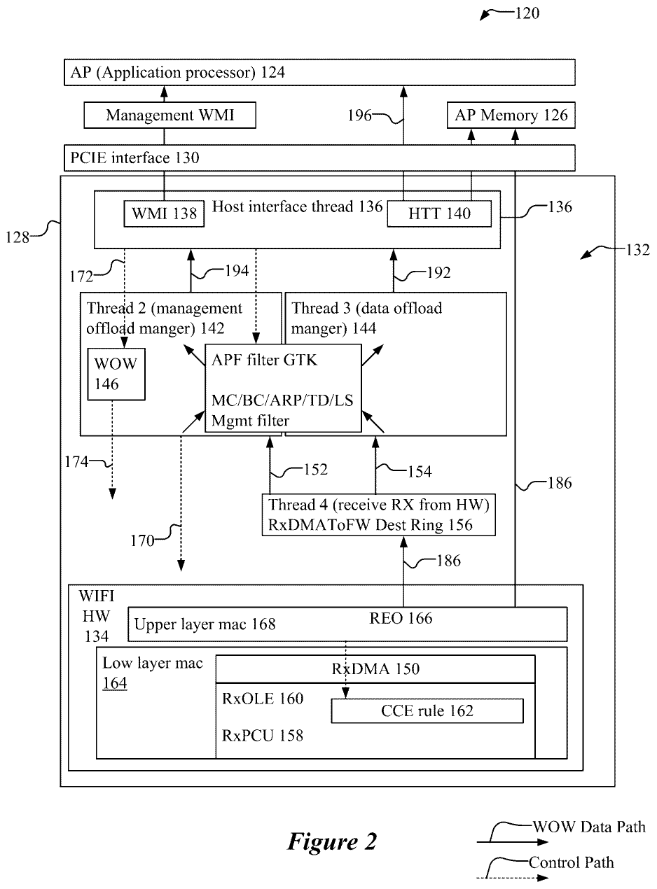

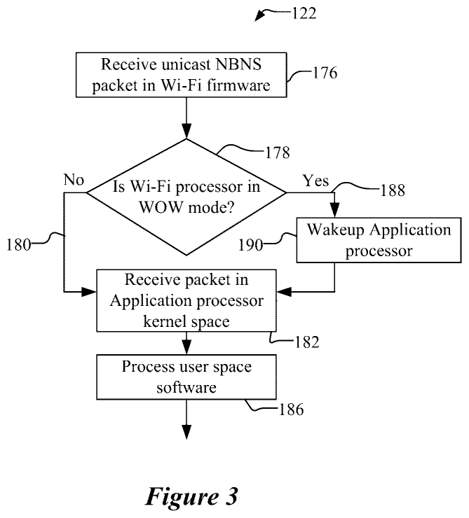

Referring to FIGS. 1-3, FIG. 2 shows a diagram of an example wireless communication device operable to handle packets in a wireless communication network 120. FIG. 3 shows a flowchart illustrating an example process for handling packets received by a wireless communication device 122. The STA 104 includes an application processor 124 and associated memory 126. The application processor 124 is coupled to a Wi-Fi processor 128 through a PCI Express interface 130, which allows high bandwidth communications between the application processor 124 and Wi-Fi processor 128 and other associated STA 104 hardware. The Wi-Fi processor 128 includes a software module 132 and a hardware module 134, which executes the software 132 operable on the hardware 134.

The software module 132 includes a host interface thread 136, which include Wireless Messaging Interface (WMI) 138 module which handles commands and event, as well as transmit (TX) and receive (RX) management packets and Host Target Transport (HTT) 140 module which handles the receipt and sending of data packets; The software module 132 also include the offload manager thread 142, which handles management and control RX packets; handles the data offload manager thread 144; and handles broadcast and multicast packets in WOW mode 146. The software module 132 receives thread carry data 148 from RxDMA firmware destination ring 150, which is delivered 152 to the offload manager thread 142 and delivered 154 to the data offload manager thread 144 by the receive thread 156.

The hardware module 134 includes a Receive Protocol Unit (RxPCU) 158, a Receive Offload Engine (RxOLE) 160, which offloads the firmware tasks related to packet processing and includes the Custom Classification Engine (CCE) rules 162, all within the Lower Layer Mac (LLM) 164, and a Receive Re-order engine ring module (REO) 166 within the Upper Layer Mac (ULM) 168.

The CCE rules 162 configuration are set by the Wi-Fi offload manager 142 via line 170, which offload patterns are configured opportunistically whenever configuration is available. The Wi-Fi processor 128 software module 132 retains the offload pattern configuration.

Filtering of data packets is done by a hardware multicast hash filter in the RxPCU 158, the CCE rules 162 in the RxOLE, and CCE rules 162 for filtering in the Active mode and the Delivery Traffic Indication Map (DTIM) mode.

Packets first enter the RxPCU module 158 of the Wi-Fi hardware 134, then are passed to the RxOLE module 160. Packets will be forwarded or dropped based on the forward bit/drop bit configuration. Packets that are not of interest are filtered or dropped to reduce the incidence of waking up the application processor 124 and the PCIe bus subsystem 130. When the application processor 124 enters suspended mode, it suspends all WLAN driver threads and disables net TX queues during cfg802.11 suspend. The application processor 124 will send a WOW command 172 to the Wi-Fi processor 128 when the PCIe interface 130 is paused. The firmware data path ring is switched 174 to local ring when WOW is enabled. All data packets will then be routed to the RxDMA firmware 150 destination ring and checked by the CCE rules 162.

When a unicast packet is received 176, the RxDMA firmware 150 determines if the Wi-Fi software 132 is in WOW mode 178. If not in WOW mode 180, the packet is sent 182 to the AP memory 126 kernel space via address line 184 to be acted upon by the application processor 124. Other APPs running on the application processor 124 may then be serviced 186. If Wi-Fi processor 128 is in WOW mode 188, a wakeup event 190 is generated and sent to the application processor 124 via control line 192 to handle the unicast packet. The firmware data path is switched from local ring to remote ring to handle the unicast packet.

If no packets are active on a STA 104 and no packets are received by the Wi-Fi processor 128 from the AP 102, and no data active on the application processor 124, the application processor 124 will enter a suspend or standby mode and the Wi-Fi processor 128 will enter WOW mode. When the AP 102 sends a packet to the STA 104, it is received by the Wi-Fi processor 128, and the RxPCU 158 firmware determines the packet type. If the packet is a broadcast packet or a multicast packet, the packet is dropped by the RxPCU 158. If the packet is a unicast packet, the packet is sent to the RxOLE 160 and the CCE rules 162 are applied. If the packet is not configured in the CCE rules 162, such as an Address Resolution Protocol (ARP) or Tunneled Direct Link Setup (TDLS) packet, the packet is routed to the offload manager thread 142. The offload manager thread 142 sends a wakeup event 194 to the host interface thread 136 to handle this packet. The host interface thread 136 sends Rx packets indication 196 to the application processor 124 and wakes up the application processor 124 by an interrupt request (IRQ). The application processor 124 handles the packet or packets, and the Wi-Fi processor 128 exits WOW mode and enables the remote ring to receive packets. If there is no more data or activities received by the application processor 124, it enters the suspend or standby mode again and commands the Wi-Fi processor 128 to enter WOW mode, and the cycle repeats.

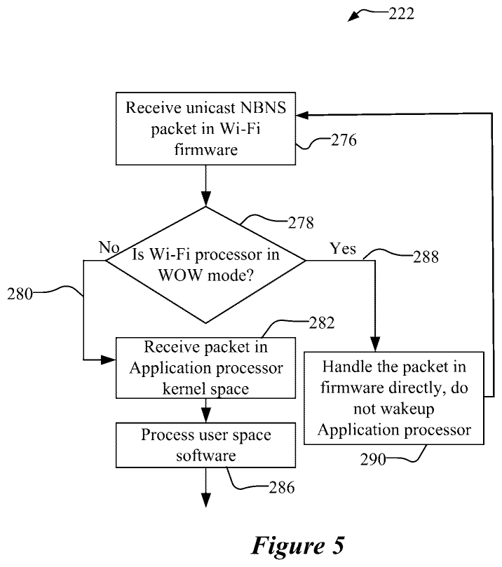

Referring to FIGS. 1, 4 and 5, FIG. 4 shows a diagram of an example wireless communication device that supports handling Network Basic Input/Output System (NetBIOS) over Transmission Control Protocol/Internet Protocol (TCP/IP) (NBT) protocol frames for reduced power consumption 220. FIG. 5 shows a flowchart illustrating an example process that supports handling NBT protocol frames for reduced power consumption 222. The apparatus 220 and method 222 support handling a NBNS unicast packet received by an STA 104 such as a cell phone, for example. The STA 104 includes an application processor (AP processor) 224 and associated memory 226. The application processor 224 is coupled to a Wi-Fi processor 228 through a PCI Express interface 230, which allows high bandwidth communications between the application processor 224 and Wi-Fi processor 228 and other associated STA 104 hardware. The Wi-Fi processor 228 includes a software module 232 and a hardware module 234, which executes the software 232 operable on the hardware 234.

The software module 232 includes a host interface thread 236, which include Wireless Messaging Interface (WMI) 238 module which handles commands and event, as well as transmit (TX) and receive (RX) management packets and Host Target Transport (HTT) 240 module which handles the receipt and sending of data packets; handles the offload manager thread 242, which handles management and control RX packets; handles the data offload manager thread 244; and handles broadcast and multicast packets in WOW mode 246 when the PCIE interface 230 is down. The software module 232 receives thread carry data 248 from RxDMA firmware destination ring 250, which is delivered 252 to the offload manager thread 242 and delivered 254 to the data offload manager thread 244 by the receive thread 256.

The hardware module 234 includes a Receive Protocol Unit (RxPCU) 258, a Receive Offload Engine (RxOLE) 260, which offloads the firmware tasks related to packet processing and includes the Custom Classification Engine (CCE) rules 262, all within the Lower Layer Mac (LLM) 264, and a Receive Re-order engine ring module (REO) 266 within the Upper Layer Mac (ULM) 268.

The CCE rules 262 are configured by the application processor 124 via the User Datagram Protocol (UDP) port (default port number 137), by configuring the NBNS NetBios node query response. The application processor 124 also configures the NBNS NetBios node status packet content, including the detail information and capability. Configuration of the CCE filter rule by the application processor 124 is through the WMI 238 command to the offload manager 242 of the Wi-Fi processor 228. The CCE rule configuration is set by the Wi-Fi offload manager 242 via line 270, which offload patterns are configured opportunistically to the Wi-Fi hardware module 134 whenever configuration is available. The Wi-Fi processor 228 software module 232 retains the offload pattern configuration. The CCE rules 262 are configured to check for packets that are both unicast and NBNS.

Filtering of data packets is done by a hardware multicast hash filter in the RxPCU 258, the CCE rules 262 in the RxOLE, and CCE rules 262 for filtering in the Active mode and the Delivery Traffic Indication Map (DTIM) mode.

Packets first enter the RxPCU module 258 of the Wi-Fi hardware 234, then are passed to the RxOLE module 260. Packets will be forwarded or dropped based on the forward bit/drop bit configuration. Packets that are not of interest are filtered or dropped to reduce the incidence of waking up the application processor 224 and the PCIe bus subsystem 230. When the application processor 224 enters suspended mode, it suspends all WLAN driver threads and disables net TX queues during cfg802.11 suspend. The application processor 224 will send a WOW command 272 to the Wi-Fi processor 228 when the PCIe interface 230 is paused. The firmware data path ring is switched 274 to local ring when WOW is enabled. All data packets will then be routed to the RxDMA firmware 250 destination ring and checked by the CCE rules 262.

At block 276, receive unicast NBNS packet in RxDMA firmware 250. At block 278, the RxDMA firmware 250 determines if the Wi-Fi software 232 is in WOW mode 278. If not in WOW mode (path 280), at block 282 the packet is sent to the AP memory 226 kernel space via address line 284 to be acted upon by the application processor 224. Other APPs running on the application processor 224 may then be serviced at block 286. If Wi-Fi processor 228 is in WOW mode (path 288), at block 290 the packet is handled in firmware directly and the application processor is not woken up. In some examples, the RxOLE 260 routes the packets to the FW offload module 256 based on the forward bit set in the CCE rule 262 and the UDP port number. The RxDMA to FW destination ring 256 moves the data from the RxDMA 250 firmware destination ring to the offload manager 242 and the data offload manager 244 threads. The Wi-Fi processor 228 data threads check the unicast packets, and if they match the CCE rule with NBNS packets 262, the packets are handled by the NBNS data handle thread 292.

A general parser module in the Wi-Fi software module 232 handles the packet process. The general parser module fetches the required information directly from the member of each L2/L3/L4 layer and checks the data frame L2 layer parser for either type. The L3 layer is checked if the TCP/UDP, L3 is valid, depending on whether L3 exists or not, the header offset, and protocol type. The general parser module handles the NBNS packets based on the RFC001 and RFC002 specifications.

The NBNS name services packets include several conditions. First, if the packet is NODE STATUS REQUEST, then the NODE STATUS RESPONSE is sent to the peer. The NODE STATUS RESPONSE can be POSITIVE NAME REGISTRATION RESPONSE, or NEGATIVE NAME REGISTRATION RESPONSE with data. Second, if the NBNS packet is NAME QUERY REQUEST, the node status response can be POSITIVE NAME QUERY RESPONSE, or NEGATIVE NAME QUERY RESPONSE, or REDIRECT NAME QUERY RESPONSE. For each of these examples, all of the required functions for NBNS register, refresh, query and quit are included in the unicast packet mode.

If no packets are active on a STA 104 and no packets are received by the Wi-Fi processor 228 from the AP 102, and no data active on the application processor 224, the application processor 224 will enter a suspend or standby mode and the Wi-Fi processor 228 will enter WOW mode. When the AP 102 sends a packet to the STA 104, it is received by the Wi-Fi processor 228, and the RxPCU 258 firmware determines the packet type. If the packet is a broadcast packet or a multicast packet, the packet is dropped by the RxPCU 258. If the packet is a unicast packet, the packet is sent to the RxOLE 260 and the CCE rules 262 are applied. If the packet is not configured in the CCE rules 262, the packet is routed to the offload manager thread 242. The offload manager thread 242 sends a wakeup event 294 to the host interface thread 236 to handle this packet. The host interface thread 236 sends Rx packets indication 296 to the application processor 224 and wakes up the application processor 224 by an interrupt request (IRQ). The application processor 224 handles the packet or packets, and the Wi-Fi processor 228 exits WOW mode and enables the remote ring to receive packets. The application processor 224 can read the cached NBNS processing results 292 at this period for sync. If there is no more data or activities received by the application processor 224, it enters the suspend or standby mode again and commands the Wi-Fi processor 228 to enter WOW mode, and the cycle repeats.

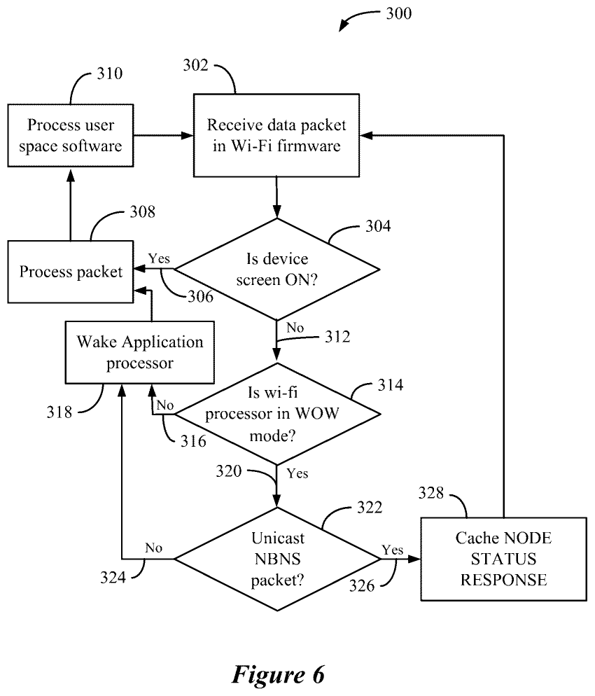

Referring to FIG. 6, a flowchart illustrating an example process that supports handling NBT protocol frames for reduced power consumption is shown, generally indicated by reference numeral 300. A Wi-Fi data packet is received by the wireless communication device's Wi-Fi receiver 302. A check is made to determine if the wireless communication device's screen is ON 304. If the wireless communication device's screen is ON 306, the Wi-Fi data packet is processed 308, and any other user applications are serviced in the user space 310. The wireless communication device then waits to receive another data packet 302.

If the wireless communication device's screen is not ON 312, a check is made to determine if the Wi-Fi processor is in WOW mode 314. If the Wi-Fi processor is not in WOW mode 316, a wakeup message is sent to the application processor 318, the Wi-Fi data packet is processed 308, and any other user applications are serviced in the user space 310. The wireless communication device then waits to receive another data packet 302.

If the Wi-Fi processor is in WOW mode 320, a check is made to determine if the Wi-Fi data packet is an NBNS packet 322. The Wi-Fi data packet is not an NBNS packet 324, a wakeup message is sent to the application processor 318, the Wi-Fi data packet is processed 308, and any other user applications are serviced in the user space 310. The wireless communication device then waits to receive another data packet 302.

If the Wi-Fi data packet is an NBNS packet 326, the NODE STATUS RESPONSE is cached 328, and the wireless communication device then waits to receive another data packet 302.

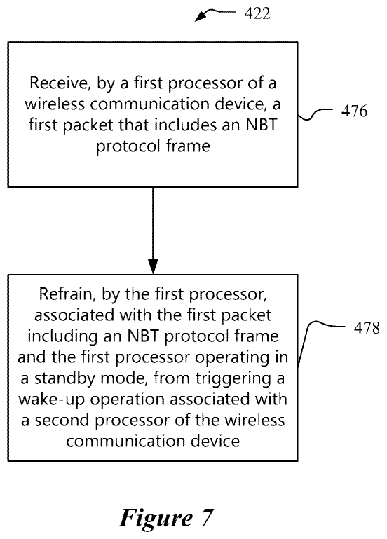

FIG. 7 shows a flowchart illustrating an example process 422 for handling NBT protocol frames for reduced power consumption. At bock 476, a first processor of a wireless communication device receives a first packet that includes an NBT protocol frame. At block 478, the first processor, associated with the first packet including an NBT protocol frame and the first processor operating in a standby mode, refrains from triggering a wake-up operation associated with a second processor of the wireless communication device.

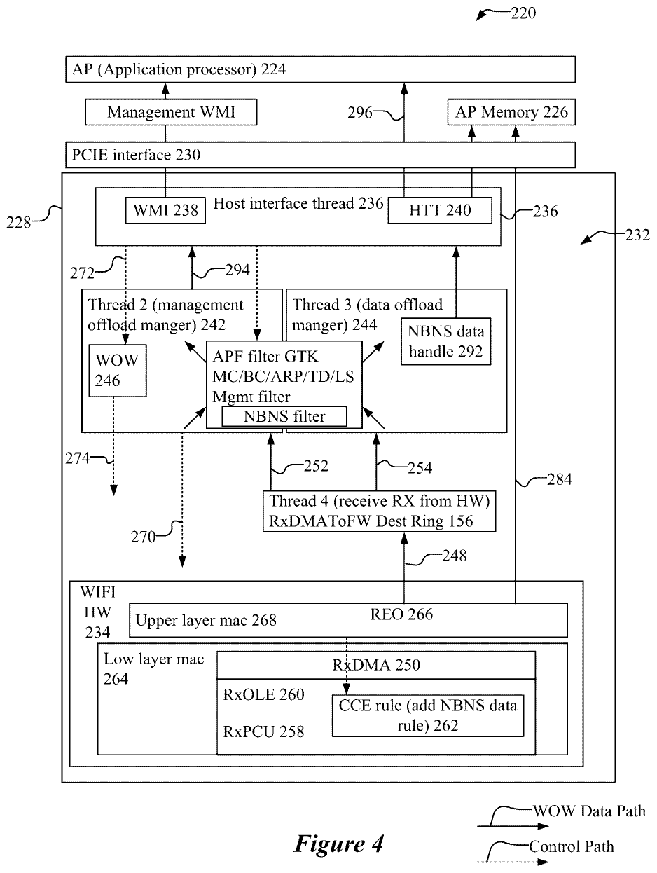

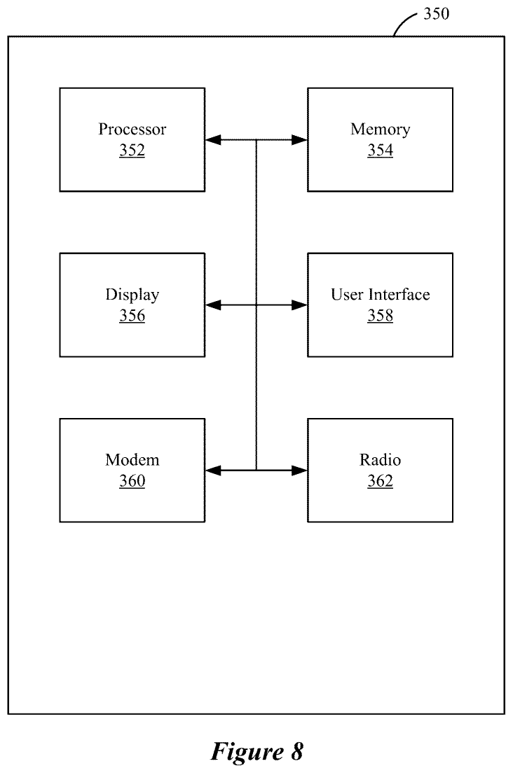

FIG. 8 shows a block diagram of an example wireless communication device that supports handling NBT protocol frames for reduced power consumption. An example wireless communication device 350 supports the novel apparatus 220 and method 222 for handling a NBNS unicast packet received by an STA 104 such as a cell phone, for example, according to some aspects of the present disclosure. In some examples, the wireless communication device 350 is configured or operable to perform the process as described with reference to FIGS. 4 and 5. In various examples, the wireless communication device 350 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor” 352); one or more radios (collectively “the radio” 362); and one or more memories or memory blocks (collectively “the memory” 354).

The wireless communication device 350 includes a processor component 352, a memory component 354, and display component 356, a user interface component 358, a modem component 360, and a radio component 362. Portions of one or more of the components 356, 358, 360, and 362 may be implemented at least in part in hardware or firmware. In some examples, at least some of the components 356, 358, 360, and 362 of the device 350 are implemented at least in part by a processor and as software stored in a memory. For example, portions of one or more of the display component 356, the user interface component 358, and the modem component 360 can be implemented as non-transitory instructions (or “code”) executable by the processor 352 to perform the functions or operations of the respective module.

In some implementations, the processor 352 may be a component of a processing system. A processing system may generally refer to a system or series of machines or components that receives inputs and processes the inputs to produce a set of outputs (which may be passed to other systems or components of, for example, the device 350). For example, a processing system of the device 350 may refer to a system including the various other components or subcomponents of the device 350, such as the processor, or a transceiver, or a communications manager, or other components or combinations of components of the device 350. The processing system of the device 350 may interface with other components of the device 350 and may process information received from other components (such as inputs or signals) or output information to other components. For example, a chip or modem of the device 350 may include a processing system, a first interface to output information and a second interface to obtain information. In some implementations, the first interface may refer to an interface between the processing system of the chip or modem and a transmitter, such that the device 350 may transmit information output from the chip or modem. In some implementations, the second interface may refer to an interface between the processing system of the chip or modem and a receiver, such that the device 350 may obtain information or signal inputs, and the information may be passed to the processing system. A person having ordinary skill in the art will readily recognize that the first interface also may obtain information or signal inputs, and the second interface also may output information or signal outputs.

The processor 352 is capable of, configured to, or operable to processes information received through the radio 362 and the modem 360, and processes information to be output through the modem 360 and the radio 362 for transmission through the wireless medium. The processor 352 may perform logical and arithmetic operations based on program instructions stored within the memory 354. The instructions in the memory 354 may be executable (by the processor 352, for example) to implement the methods described herein. In some examples, the processor 352, together with the memory 354, are capable of, configured to, or operable to facilitate high-bandwidth communication on the 5 GHz band

The memory 354 is capable of, configured to, or operable to store and communicate instructions and data to and from the processor 352.

The user interface 358 may be any device that allows a user to interact with the wireless communication device 350, such as a keyboard, a mouse, a microphone, et cetera. In aspects, the user interface 358 may be integrated with the display component 806 to present a touchscreen.

The modem 360 is capable of, configured to, or operable to modulate packets and to output the modulated packets to the radio 362 for transmission over the wireless medium. The modem 360 is similarly configured to obtain modulated packets received by the radio 362 and to demodulate the packets to provide demodulated packets.

The radio 362 includes at least one radio frequency transmitter and at least one radio frequency receiver, which may be combined into one or more transceivers. The transmitter(s) and receiver(s) may be coupled to one or more antennas. In some aspects, the processor 352, the memory 354, the modem 360, and the radio 362 may collectively facilitate the wireless communication of the wireless communication device 350 with other wireless communication devices over multiple frequency bands (such as 2.4 GHz, 5 GHz or 6 GHz).

In some examples, the wireless communication device 350 can be a device for use in a STA, such as STA 104 described with reference to FIG. 1. In some other examples, the wireless communication device 350 can be a STA that includes such a chip, SoC, chipset, package or device as well as multiple antennas. The wireless communication device 350 is capable of transmitting and receiving wireless communications in the form of, for example, wireless packets. For example, the wireless communication device can be configured or operable to transmit and receive packets in the form of physical layer PPDUs and MPDUs conforming to one or more of the IEEE 802.11 family of wireless communication protocol standards. In some examples, the wireless communication device 350 also includes or can be coupled with an application processor which may be further coupled with another memory. In some examples, the wireless communication device 350 further includes a user interface (UI) (such as a touchscreen or keypad) and a display, which may be integrated with the UI to form a touchscreen display. In some examples, the wireless communication device 350 may further include one or more sensors such as, for example, one or more inertial sensors, accelerometers, temperature sensors, pressure sensors, or altitude sensors.

In some examples, the wireless communication device 350 can be a device for use in an AP, such as AP 102 described with reference to FIG. 1. In some other examples, the wireless communication device 350 can be an AP that includes such a chip, SoC, chipset, package or device as well as multiple antennas. The wireless communication device 350 is capable of transmitting and receiving wireless communications in the form of, for example, wireless packets. For example, the wireless communication device can be configured or operable to transmit and receive packets in the form of physical layer PPDUs and MPDUs conforming to one or more of the IEEE 802.11 family of wireless communication protocol standards. In some examples, the wireless communication device 350 also includes or can be coupled with an application processor which may be further coupled with another memory. In some examples, the wireless communication device 350 further includes at least one external network interface that enables communication with a core network or backhaul network to gain access to external networks including the Internet.

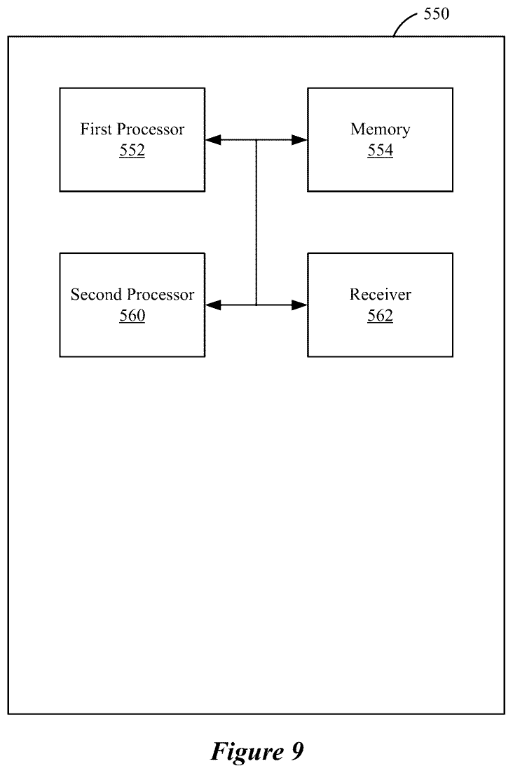

FIG. 9 shows a block diagram of an example wireless communication device 550 that supports handling NBT protocol frames for reduced power consumption. The wireless communication device 550 supports the novel apparatus 220 and method 222 for handling a NBNS unicast packet received by an STA 104 such as a cell phone, for example, according to some aspects of the present disclosure. In some examples, the wireless communication device 550 is configured or operable to perform the process 422 described with reference to FIG. 7.

The wireless communication device 550 includes a first processor 552, a memory 554, a second processor 560, and a receiver 562. In some implementations, the processors 552 and 560 may be a component of a processing system. A processing system may generally refer to a system or series of machines or components that receives inputs and processes the inputs to produce a set of outputs (which may be passed to other systems or components of, for example, the device 550). For example, a processing system of the device 550 may refer to a system including the various other components or subcomponents of the device 550, such as the processor, or a transceiver, or a communications manager, or other components or combinations of components of the device 550. The processing system of the device 550 may interface with other components of the device 550 and may process information received from other components (such as inputs or signals) or output information to other components. For example, a chip or modem of the device 550 may include a processing system, a first interface to output information and a second interface to obtain information. In some implementations, the first interface may refer to an interface between the processing system of the chip or modem and a transmitter, such that the device 550 may transmit information output from the chip or modem. In some implementations, the second interface may refer to an interface between the processing system of the chip or modem and a receiver, such that the device 550 may obtain information or signal inputs, and the information may be passed to the processing system. The first interface also may obtain information or signal inputs, and the second interface also may output information or signal outputs.

The first processor 552 is configured or operable to process, or is capable of processing, information received through the receiver 562, and can process information to be output through the receiver 562 for transmission through the wireless medium. The first processor 552 and the second processor 560 may perform logical and arithmetic operations based on program instructions stored within the memory 554. The instructions in the memory 554 may be executable by the first processor 552 and the second processor 560 to implement the methods described herein. In some examples, the first processor 552 and the second processor 560, together with the memory 554, are capable of facilitating, or are configured or operable to facilitate, high-bandwidth communication on the 5 GHz band.

The memory 554 is configured or operable to store and communicate instructions and data to and from the first processor 552 and the second processor 560.

The receiver 562 includes at least one radio frequency transmitter and at least one radio frequency receiver, which may be combined into one or more transceivers. The transmitter(s) and receiver(s) may be coupled to one or more antennas. In some aspects, the first processor 552, the second processor 560, the memory 554, and the receiver 562 may collectively facilitate the wireless communication of the wireless communication device 550 with other wireless communication devices over multiple frequency bands (such as 2.4 GHz, 5 GHz, or 6 GHz).

Implementation examples are described in the following numbered clauses:
Clause 1: A wireless communication device, comprising a memory; a first processor communicatively coupled with the memory, the first processor operable to receive a first packet that includes a Network Basic Input/Output System (NetBIOS) over Transmission Control Protocol/Internet Protocol (TCP/IP) (NBT) protocol frame, and refrain, associated with the first packet including an NBT protocol frame and the first processor operating in a standby mode, from triggering a wake-up operation associated with a second processor of the wireless communication device.
Clause 2: The wireless communication device of clause 1, wherein the NBT protocol frame is a NetBIOS Name Service (NBNS) frame and the refraining from triggering the wake-up operation associated with the second processor is further associated with the NBT protocol frame being an NBNS frame.
Clause 3: The wireless communication device of clause 2, wherein the first processor is further operable to receive a second packet that does not include an NBNS frame; and communicate, associated with receiving the second packet that does not include an NBNS frame, a wake-up message to the second processor.
Clause 4: The wireless communication device of clause 3, wherein the NBNS frame includes a NODE STATUS REQUEST, the first processor is further operable to, associated with the NBNS frame including a NODE STATUS REQUEST, cache a NODE STATUS RESPONSE in the memory, and the second processor is operable to, associated with receiving the wake-up message, process the NODE STATUS RESPONSE.
Clause 5: The wireless communication device of clause 3, wherein the NBNS frame includes a NAME RELEASE REQUEST and DEMAND; the first processor is further operable to, associated with the NBNS frame including a NAME RELEASE REQUEST and DEMAND, cache a NODE STATUS RESPONSE in the memory; and the second processor is operable to, associated with receiving the wake-up message, process the NODE STATUS RESPONSE
Clause 6: The wireless communication device of clause 3, wherein the NBNS frame includes a NAME QUERY REQUEST; the first processor is further operable to, associated with the NBNS frame including a NAME QUERY REQUEST, cache a NODE STATUS RESPONSE in the memory; and the second processor is operable to, associated with receiving the wake-up message, process the NODE STATUS RESPONSE.
Clause 7: A method for wireless communication performable by a wireless communication device, comprising receiving, by a first processor of the wireless communication device, a first packet that includes a Network Basic Input/Output System (NetBIOS) over Transmission Control Protocol/Internet Protocol (TCP/IP) (NBT) protocol frame; refraining, by the first processor, associated with the first packet including a NBT protocol frame and the first processor operating in standby mode, from triggering a wake-up operation associated with a second processor of the wireless communication device.
Clause 8: The method of clause 7, wherein the NBT protocol frame is a NetBIOS Name Service (NBNS) frame and the refraining from triggering the wake-up operation associated with the second processor is further associated with the NBT protocol frame being an NBNS frame.
Clause 9: The method of clause 8, further comprising receiving, by the first processor, a second packet that does not include an NBNS frame; and communicating, by the first processor, associated with receiving the second packet that does not include an NBNS frame, a wake-up message to the second processor.
Clause 10: The method of clause 9, wherein the NBNS frame includes a NODE STATUS REQUEST, the method further comprising caching, by the first processor, in a memory of the wireless communication device, a NODE STATUS RESPONSE associated with the NBNS frame including a NODE STATUS REQUEST; and processing, by the second processor, associated with receiving the wake-up message, the NODE STATUS RESPONSE.
Clause 11: The method of clause 9, wherein the NBNS frame includes a NAME RELEASE REQUEST and DEMAND, the method further comprising caching, by the first processor, in a memory of the wireless communication device, a NODE STATUS RESPONSE associated with the NBNS frame including a NAME RELEASE REQUEST and DEMAND; and processing, by the second processor, associated with receiving the wake-up message, the NODE STATUS RESPONSE.
Clause 12: The method of clause 9, wherein the NBNS frame includes a NAME QUERY REQUEST, the method further comprising caching, by the first processor, in a memory of the wireless communication device, a NODE STATUS RESPONSE associated with the NBNS frame including a NAME QUERY REQUEST; and processing, by the second processor, associated with receiving the wake-up message, the NODE STATUS RESPONSE.

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, measuring, and the like. Also, “determining” can include receiving (such as receiving information), accessing (such as accessing data stored in memory), transmitting (such as transmitting information) and the like. Also, “determining” can include resolving, selecting, obtaining, choosing, establishing and other such similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b.

As used herein, “based on” is intended to be interpreted in the inclusive sense, unless otherwise explicitly indicated. For example, “based on” may be used interchangeably with “based at least in part on,” “associated with”, or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information.

The various illustrative components, logic, logical blocks, modules, circuits, operations and algorithm processes described in connection with the examples disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A wireless communication device, comprising:
a memory;
a first processor communicatively coupled with the memory, the first processor operable to:
receive a first packet that includes a Network Basic Input/Output System (NetBIOS) over Transmission Control Protocol/Internet Protocol (TCP/IP) (NBT) protocol frame; and
refrain, associated with the first packet including an NBT protocol frame and the first processor operating in a standby mode, from triggering a wake-up operation associated with a second processor of the wireless communication device.

2. The wireless communication device of claim 1, wherein the NBT protocol frame is a NetBIOS Name Service (NBNS) frame and the refraining from triggering the wake-up operation associated with the second processor is further associated with the NBT protocol frame being an NBNS frame.

3. The wireless communication device of claim 2, wherein the first processor is further operable to:
receive a second packet that does not include an NBNS frame; and
communicate, associated with receiving the second packet that does not include an NBNS frame, a wake-up message to the second processor.

4. The wireless communication device of claim 3, wherein:
the NBNS frame includes a NODE STATUS REQUEST;
the first processor is further operable to, associated with the NBNS frame including a NODE STATUS REQUEST, cache a NODE STATUS RESPONSE in the memory; and
the second processor is operable to, associated with receiving the wake-up message, process the NODE STATUS RESPONSE.

5. The wireless communication device of claim 3, wherein:
the NBNS frame includes a NAME RELEASE REQUEST and DEMAND;
the first processor is further operable to, associated with the NBNS frame including a NAME RELEASE REQUEST and DEMAND, cache a NODE STATUS RESPONSE in the memory; and
the second processor is operable to, associated with receiving the wake-up message, process the NODE STATUS RESPONSE.

6. The wireless communication device of claim 3, wherein:
the NBNS frame includes a NAME QUERY REQUEST;
the first processor is further operable to, associated with the NBNS frame including a NAME QUERY REQUEST, cache a NODE STATUS RESPONSE in the memory; and
the second processor is operable to, associated with receiving the wake-up message, process the NODE STATUS RESPONSE.

7. A method for wireless communication performable by a wireless communication device, comprising:
receiving, by a first processor of the wireless communication device, a first packet that includes a Network Basic Input/Output System (NetBIOS) over Transmission Control Protocol/Internet Protocol (TCP/IP) (NBT) protocol frame;
refraining, by the first processor, associated with the first packet including a NBT protocol frame and the first processor operating in a standby mode, from triggering a wake-up operation associated with a second processor of the wireless communication device.

8. The method of claim 7, wherein the NBT protocol frame is a NetBIOS Name Service (NBNS) frame and the refraining from triggering the wake-up operation associated with the second processor is further associated with the NBT protocol frame being an NBNS frame.

9. The method of claim 8, further comprising:
receiving, by the first processor, a second packet that does not include an NBNS frame; and
communicating, by the first processor, associated with receiving the second packet that does not include an NBNS frame, a wake-up message to the second processor.

10. The method of claim 9, wherein the NBNS frame includes a NODE STATUS REQUEST, the method further comprising:
caching, by the first processor, in a memory of the wireless communication device, a NODE STATUS RESPONSE associated with the NBNS frame including a NODE STATUS REQUEST; and
processing, by the second processor, associated with receiving the wake-up message, the NODE STATUS RESPONSE.

11. The method of claim 9, wherein the NBNS frame includes a NAME RELEASE REQUEST and DEMAND, the method further comprising:
caching, by the first processor, in a memory of the wireless communication device, a NODE STATUS RESPONSE associated with the NBNS frame including a NAME RELEASE REQUEST and DEMAND; and
processing, by the second processor, associated with receiving the wake-up message, the NODE STATUS RESPONSE.

12. The method of claim 9, wherein the NBNS frame includes a NAME QUERY REQUEST, the method further comprising:
caching, by the first processor, in a memory of the wireless communication device, a NODE STATUS RESPONSE associated with the NBNS frame including a NAME QUERY REQUEST; and
processing, by the second processor, associated with receiving the wake-up message, the NODE STATUS RESPONSE.
